(19) United States
(12) Patent Application Publication
(10) Pub. No.: US 2026/0253913 A1
(43) Pub. Date: Aug. 27, 2026

(54) CARBON-SUPPORTED METAL CATALYST AND PREPARATION METHOD THEREOF

(71) Applicant: GRINM (Guangdong) Institute for Advanced Materials and Technology, Foshan (CN)

(72) Inventors: Rongyue Wang, Foshan (CN); Xuanxuan Bi, Jining (CN); Zhongwei Chen, Dalian (CN)

(21) Appl. No.: 19/577,980

(22) Filed: Mar. 25, 2026

Related U.S. Application Data
(63) Continuation of application No. PCT/CN2025/140230, filed on Dec. 5, 2025.

(30) Foreign Application Priority Data
Jan. 22, 2025 (CN) 202510099772.3

(51) Int. Cl. H01M 4/92

(52) U.S. Cl. CPC H01M 4/926

(57) ABSTRACT

A carbon-supported metal catalyst and a preparation method thereof are provided. The preparation method includes: dispersing platinum acetylacetonate, a transition metal acetylacetonate salt, and a carbon material in a solvent, removing the solvent by drying to obtain a precursor, and performing a first annealing on the precursor in an air atmosphere to obtain a mixture; performing a second annealing on the mixture in an argon-hydrogen atmosphere to obtain an annealed mixture, cooling, then performing acid washing, followed by washing and drying to obtain a resulting product, and performing a third annealing on the resulting product in the argon-hydrogen atmosphere to obtain the carbon-supported metal catalyst. By the preparation method, platinum-based intermetallic compound nanoparticles encapsulated by a tunable carbon layer are prepared, effectively preventing particle agglomeration. The resulting catalyst exhibits a high degree of order, fine particle size, uniform distribution, and excellent activity.

### CROSS-REFERENCE TO RELATED APPLICATION

This application claims priority to Chinese Patent Application No. 202510099772.3, filed Jan. 22, 2025, which is herein incorporated by reference in its entirety.

### TECHNICAL FIELD

The disclosure relates to the field of fuel cell technologies, and more particularly to a carbon-supported metal catalyst and a preparation method thereof.

### BACKGROUND

To achieve the dual carbon goals set forth by China, hydrogen energy has become an indispensable component of the future clean energy landscape. Fuel cells, which have been proposed, can effectively convert the hydrogen energy into electrical energy and demonstrate promising application prospects in fields such as power conversion devices and heavy-duty truck drive. Platinum and platinum-based alloys are essential catalyst materials for proton exchange membrane fuel cells (PEMFCs) and are also primary factors influencing the conversion efficiency and application cost of the PEMFCs. However, current commercial fuel cell vehicles, such as the Toyota Mirai, utilize a relatively high amount of platinum, with a platinum loading of approximately 36 grams (g). This high application cost is a major factor limiting the widespread use of the PEMFCs.

A current effective strategy for reducing the platinum loading is to alloy platinum with first-row transition metals. Specifically, incorporating smaller transition metal atoms into a platinum-based alloy induces beneficial strain and alloying effects, thereby enhancing the oxygen reduction reaction (ORR) activity of platinum alloy catalysts. For the platinum-based alloy catalysts, the ordering degree of the catalyst generally increases with rising temperature, and this ordering degree is positively correlated with the catalytic activity. However, achieving a high degree of atomic order often requires high-temperature annealing. This high-temperature annealing treatment inevitably accelerates metal sintering, leading to nanoparticle agglomeration and a consequent decrease in activity. Various preparation methods have been developed to produce fine nanoparticles, particularly for platinum-based catalyst materials used in fuel cells. These methods include, for example, coating with a polymer or metal oxide protective shell before annealing to limit particle size, or preparing via small-molecule-assisted impregnation. However, these methods involve cumbersome procedures, and the thickness of the protective shell is difficult to control, which can easily affect the activity of the platinum-based catalyst. Therefore, further improvement and development of the related art are still needed.

### SUMMARY

In view of shortcomings and deficiencies of the related art, the disclosure provides a carbon-supported metal catalyst and a preparation method thereof, aiming to overcome problems, such as cumbersome procedures and the tendency to affect catalyst activity in methods in the related art for controlling metal particle agglomeration in catalysts.

Technical solutions of the disclosure are as follows.

In one aspect, the disclosure provides a preparation method of a carbon-supported metal catalyst, including steps of:
dispersing platinum acetylacetonate, a transition metal acetylacetonate salt, and a carbon material in a solvent, removing the solvent by drying to obtain a precursor, and performing a first annealing on the precursor in an air atmosphere to obtain a mixture; and
performing a second annealing on the mixture in an argon-hydrogen atmosphere to obtain an annealed mixture, cooling the annealed mixture to obtain a cooled mixture, then performing acid washing (also referred to as acid leaching) on the cooled mixture, followed by washing and drying to obtain a resulting product, and performing a third annealing on the resulting product in the argon-hydrogen atmosphere to obtain the carbon-supported metal catalyst.

By using the platinum acetylacetonate and the transition metal acetylacetonate salt, after uniform impregnation, annealing directly in an air atmosphere, followed by two-step gas-phase reduction in an argon-hydrogen atmosphere, platinum-based intermetallic compound nanoparticles encapsulated by a tunable carbon layer can be prepared. This method effectively prevents particle agglomeration and yields the carbon-supported metal catalyst having fine, uniformly distributed catalyst particles with a high degree of order and excellent activity.

In some embodiments, a temperature of the first annealing is in a range of 100-500° C. and a period of the first annealing is in a range of 5-500 minutes (min).

The mixture exhibits a weight loss in a range of 1-50 wt % after the first annealing compared to before the first annealing.

In the disclosure, the carbon layer is formed from acetylacetonate groups. By controlling the temperature and weight loss during the first annealing, the thickness of the subsequently formed carbon layer and its encapsulation performance on the reduced metal particles can be controlled, which is beneficial for improving the catalytic effect of the catalyst.

In some embodiments, the temperature of the first annealing is 176° C. and the period of the first annealing is in a range of 20-40 min.

The mixture exhibits a weight loss of 1-30 wt % after the first annealing compared to before the first annealing.

In the disclosure, by adjusting the treatment based on the acetylacetonate groups, specifically using the temperature of 176° C. and the weight loss not exceeding 30 wt %, catalytic activity can be enhanced.

In some embodiments, a temperature of the second annealing is in a range of 400-1100° C. and a period of the second annealing is in a range of 10 min to 8 hours (h).

In the disclosure, by performing annealing in an argon-hydrogen atmosphere, the acetylacetonate groups decompose and form a carbon layer that encapsulates the reduced metal nanoparticles, effectively preventing particle agglomeration.

In some embodiments, the acid washing is performed in sulfuric acid with a concentration in a range of 0.1-1 mole per liter (mol/L) at 60° C. for 12 h.

In some embodiments, a temperature of the third annealing is in a range of 100-500° C. and a period of the third annealing is in a range of 10 min to 6 h.

In the disclosure, the third annealing stabilizes the structural integrity of the platinum-transition metal intermetallic framework, enhancing stability.

In some embodiments, the carbon material includes graphitized carbon or a commercial carbon material.

The graphitized carbon is prepared by heat-treating an amorphous carbon material in an inert atmosphere or a nitrogen atmosphere at 1200-3000° C. for 10 min to 6 h, followed by natural cooling to room temperature.

The commercial carbon material is one selected from the group consisting of carbon black (Vulcan® XC72), conductive carbon black (Ketjenblack® KB300, Ketjenblack® KB600), carbon black (BP 2000), and graphite (Toray® carbon).

In some embodiments, the transition metal acetylacetonate salt is one or more selected from the group consisting of iron acetylacetonate, nickel acetylacetonate, molybdenum acetylacetonate, vanadium acetylacetonate, copper acetylacetonate, manganese acetylacetonate, zinc acetylacetonate, titanium acetylacetonate, tungsten acetylacetonate, chromium acetylacetonate, and zirconium acetylacetonate.

In some embodiments, a platinum loading in the carbon-supported metal catalyst is in a range of 1-60 wt %.

In another aspect, the disclosure also provides a carbon-supported metal catalyst, including a carbon support loaded with metal nanoparticles, wherein a surface of the metal nanoparticles has a carbon layer by encapsulation.

The carbon support is one of solid nanoparticles or a porous continuous structure, the solid nanoparticles having a particle size of 1 nm to 300 micrometers (μm).

The metal nanoparticles have a particle size in a range of 1-20 nm.

A pore structure within the carbon layer is one of a loose porous structure, a trace pore structure, or a closed non-porous structure.

The encapsulation is one of no encapsulation, partial encapsulation, or complete encapsulation.

The carbon layer has a thickness of 0.001 nm to 50 nm.

The carbon layer is in a range of 0 to 50 layers in quantity.

Beneficial effects: By using the platinum acetylacetonate and the transition metal acetylacetonate salt, after uniform impregnation, annealing directly in an air atmosphere, followed by two-step gas-phase reduction in an argon-hydrogen atmosphere, platinum-based intermetallic compound nanoparticles encapsulated by a tunable carbon layer can be prepared. This method effectively prevents particle agglomeration and yields the carbon-supported metal catalyst having fine, uniformly distributed catalyst particles with a high degree of order and excellent activity.

### BRIEF DESCRIPTION OF DRAWINGS

FIG. 1A illustrates an electron microscope image of particle distribution of a graphitized carbon-supported metal catalyst according to an embodiment 1 of the disclosure.

FIG. 1B illustrates an electron microscope image of particles of the graphitized carbon-supported metal catalyst according to the embodiment 1 of the disclosure.

FIG. 2 illustrates X-ray diffraction (XRD) patterns of the graphitized carbon-supported metal catalyst according to the embodiment 1 of the disclosure.

FIG. 3 illustrates a thermogravimetric analysis (TGA) curve of a precursor according to the embodiment 1 of the disclosure, obtained by heating in air at a rate of 5° C./min.

FIG. 4A illustrates an electron microscope image of particle distribution of a graphitized carbon-supported metal catalyst according to an embodiment 2 of the disclosure after annealing at 152° C. in an air atmosphere.

FIG. 4B illustrates an electron microscope image of particle distribution of a graphitized carbon-supported metal catalyst according to the embodiment 2 of the disclosure after annealing at 164° C. in an air atmosphere.

FIG. 4C illustrates an electron microscope image of particle distribution of a graphitized carbon-supported metal catalyst according to the embodiment 2 of the disclosure after annealing at 188° C. in an air atmosphere.

FIG. 4D illustrates ORR polarization curves for the graphitized carbon-supported metal catalysts according to the embodiment 1 and the embodiment 2 of the disclosure after annealing at 152° C., 164° C., 176° C., and 188° C., respectively, in an air atmosphere.

FIG. 5 illustrates XRD patterns of the graphitized carbon-supported metal catalysts according to the embodiment 2 of the disclosure after annealing at 152° C., 164° C., and 188° C., respectively, in an air atmosphere.

FIG. 6 illustrates an electron microscope image of particle distribution of a graphitized carbon-supported metal catalyst according to an embodiment 3 of the disclosure.

FIG. 7 illustrates XRD patterns of the graphitized carbon-supported metal catalyst according to the embodiment 3 of the disclosure.

FIG. 8 illustrates an electron microscope image of a particle distribution of the KB600-supported platinum-based intermetallic compound catalyst according to an embodiment 4 of the disclosure.

FIG. 9 illustrates XRD patterns of the KB600-supported platinum-based intermetallic compound catalyst according to the embodiment 4 of the disclosure.

FIG. 10A illustrates an electron microscope image of particle distribution of a catalyst according to a comparative example 1 of the disclosure.

FIG. 10B illustrates an electron microscope image of particles of the catalyst according to the comparative example 1 of the disclosure.

FIG. 11 illustrates XRD patterns of the catalyst according to the comparative example 1 of the disclosure.

FIG. 12 illustrates ORR polarization curves for the graphitized carbon-supported metal catalyst according to an embodiment 1 of the disclosure and a commercial platinum carbon catalyst according to a comparative example 2 of the disclosure.

FIG. 13 illustrates ORR polarization curves for the KB600-supported platinum-based intermetallic compound catalyst according to the embodiment 4 of the disclosure and the commercial platinum carbon catalyst according to the comparative example 2 of the disclosure.

FIG. 14 illustrates ORR polarization curves for the graphitized carbon-supported metal catalyst according to the embodiment 1 of the disclosure and the graphitized carbon-supported catalyst according to the comparative example 1 of the disclosure.

FIG. 15 illustrates a bar chart comparing specific activity values of the embodiment 1, the comparative example 1, and the comparative example 2 of the disclosure.

### DETAILED DESCRIPTION OF EMBODIMENTS

The disclosure provides a carbon-supported metal catalyst and a preparation method thereof. To make purposes, technical solutions, and effects of the disclosure clearer and more explicit, the disclosure is further described in detail below. It should be understood that specific embodiments described herein are merely for explaining the disclosure and are not intended to limit the disclosure.

Currently, platinum-based intermetallic compound catalysts typically require high-temperature annealing to achieve a high degree of order. The degree of order of such catalysts is positively correlated with their catalytic performance. However, high-temperature annealing inevitably accelerates metal sintering, producing larger crystallites, which leads to agglomeration of the nanoparticles in the platinum-based intermetallic compound catalyst, reducing the specific surface area and mass activity, and consequently significantly decreasing the activity and stability of the catalyst.

To address this problem, the disclosure provides a preparation method of a carbon-supported metal catalyst, including the following steps:
S1, dispersing platinum acetylacetonate, a transition metal acetylacetonate salt, and a carbon material in a solvent, removing the solvent by drying to obtain a precursor, and performing a first annealing on the precursor in an air atmosphere to obtain a mixture; and
S2, performing a second annealing on the mixture in an argon-hydrogen atmosphere to obtain an annealed mixture, cooling the annealed mixture to obtain a cooled mixture, then performing acid washing on the cooled mixture, followed by washing and drying to obtain a resulting product, and performing a third annealing on the resulting product in the argon-hydrogen atmosphere to obtain the carbon-supported metal catalyst.

By using the platinum acetylacetonate and the transition metal acetylacetonate salt, after uniform impregnation, annealing directly in an air atmosphere, followed by two-step gas-phase reduction in an argon-hydrogen atmosphere, platinum-based intermetallic compound nanoparticles encapsulated by a tunable carbon layer can be prepared. This method effectively prevents particle agglomeration and yields the carbon-supported metal catalyst having fine, uniformly distributed catalyst particles with a high degree of order and excellent activity.

A ratio of platinum to transition metal is in a range of 1:(0.1-10), specifically 1:(1-1.2).

Specifically, in the disclosure, by directly using the platinum acetylacetonate and the transition metal acetylacetonate salt, the acetylacetonate groups serve as the raw material for the carbon layer. The acetylacetonate groups can decompose and reorganize to form a carbon layer that encapsulates the platinum-based intermetallic compound nanoparticles, thereby limiting agglomeration. This results in a catalyst material with uniformly distributed nanoparticles and high activity.

In step S1, the platinum acetylacetonate, the transition metal acetylacetonate salt, and graphitized carbon are dispersed in a solvent to obtain a mixture, the mixture can be uniformly mixed by ultrasonication and then dried via rotary evaporation.

In some embodiments, the carbon material includes graphitized carbon or a commercial carbon material. The graphitized carbon is prepared by heat-treating an amorphous carbon material in an inert atmosphere or a nitrogen atmosphere at 1200-3000° C. for 10 min to 6 h, followed by natural cooling to room temperature. Specifically, the graphitized carbon can also be replaced, as needed, with commonly used commercial carbon materials such as Vulcan® XC72, KB300 (Ketjen Black 300), KB600 (Ketjen Black 600), BP 2000, or Toray® carbon. Specifically, the graphitized carbon is preferred because it exhibits stronger corrosion resistance in high-temperature acidic environments compared to other carbon materials. Nevertheless, the graphitized carbon has fewer surface defects and cannot effectively support metal nanoparticles. As a result, traditional impregnation with chloroplatinic acid can lead to particle agglomeration. The adjustments made in the disclosure effectively address the issue of particle agglomeration.

In step S1, the solvent can specifically be acetone. The amount of acetone used can range from 6 to 10 milliliters (mL), and the specific amount can be selected based on the carbon material. A standard guideline is 6-10 mL of acetone per 150 milligrams (mg) of carbon material. As different carbon materials have different volumes after soaking in the solvent, it is only required that the acetone be sufficient to immerse the carbon material for adequate dispersion. In the disclosure, the acetylacetonate salts and the carbon material are uniformly dispersed in acetone to obtain a uniform solution, facilitating the subsequent uniform distribution of nanoparticles reduced via gas phase on the carbon support.

The acetone is removed by rotary evaporation. Acetone acts as a solvent for the precursor and serves a dispersing function, which does not participate in the synthesis of the material. Failure to remove the acetone would lead to uneven dispersion of the precursor, resulting in particle agglomeration.

In some embodiments, the first annealing is conducted in an air atmosphere at a temperature of 100-500° C. for a period of 5-500 min. Current methods for introducing a carbon layer via organic ligands typically require the addition of other substances, which may introduce impurities and involve more cumbersome steps, increasing costs. The disclosure uses acetylacetonate salts as organometallic salts for the target metals. The composition is relatively simple, and the carbon layer formed from the acetylacetonate groups is simpler and purer.

In some embodiments, the first annealing is conducted in an air atmosphere at a temperature of 176° C. for a period of 20-40 min. Specifically, the platinum-based intermetallic compound nanoparticles are encapsulated by a carbon layer to prevent agglomeration under high-temperature annealing conditions. However, the encapsulating carbon layer must not be too thick, as this would affect the catalytic activity of the catalyst. In the disclosure, controlling the first annealing temperature at 176° C. is specifically targeted at the acetylacetonate groups. This pre-oxidation intervention pretreatment in an air atmosphere at 176° C. allows for the regulation of the subsequent decomposition and reorganization of the acetylacetonate groups and optimizes the formed carbon layer. The catalyst encapsulated by this carbon layer achieves uniform distribution on the graphitized carbon support, facilitating the production of a carbon-supported metal catalyst with excellent oxygen reduction reaction performance.

In some embodiments, the mixture exhibits a weight loss of 1-50 wt % after the first annealing compared to before the first annealing. The weight loss can be controlled by the time and temperature of the annealing treatment. Carbon reacts at high temperatures, generally, longer times or higher temperatures result in less remaining carbon and higher weight loss. More specifically, annealing in an air atmosphere oxidizes part of the acetylacetonate groups, affecting the content of the surface carbon layer. The weight loss of the mixture before and after the first annealing influences the properties of the carbon layer. If the weight loss is too low, the carbon layer is too thick, exposing fewer active sites. Increasing the weight loss can thin the carbon layer or even prevent its formation, leading to particle agglomeration and decreased performance.

In a specific embodiment, the weight loss of the mixture after the first annealing compared to before the first annealing is not higher than 30 wt %. When the weight loss exceeds 30 wt %, particles tend to enlarge, which more easily impacts catalytic performance. Controlling the weight loss within a suitable range allows for a better balance between active sites and carbon layer thickness.

In some embodiments, the second annealing is conducted at a temperature of 400-1100° C. for a period of 10 min to 8 h. More specifically, the temperature is 700° C., and the annealing time is 6 h. In the disclosure, by performing high-temperature annealing in an argon-hydrogen atmosphere, the platinum acetylacetonate and the transition metal acetylacetonate salt in the mixture are reduced in situ to form nanoscale metal particles. Subsequently, at high temperature, the acetylacetonate groups decompose upon heating and reorganize. With continued high temperature and the continuous flow of the argon-hydrogen atmosphere, the decomposed acetylacetonate groups break down into small molecular fragments, forming a carbon layer that simultaneously encapsulates the nanoscale metal particles, limiting particle growth and effectively preventing agglomeration or sintering. Concurrently, the reduced nanoscale metal particles can achieve a high degree of order at the high temperature, yielding a catalyst material with uniformly distributed particles and high activity. The operation is simple, introduces no other impurities or elements, results in a higher degree of order for the alloy, improves stability and performance, and produces smaller particles, leading to better performance.

In some embodiments, the acid washing is performed in 0.1-1 mol/L sulfuric acid, specifically 0.25 mol/L, at 60° C. for 12 h. In the disclosure, the acid washing removes excess transition metal atoms from the surface of the metal particles, which is beneficial for improving stability.

In some embodiments, the third annealing is conducted at a temperature of 100-500° C. for a period of 10 min to 6 h. More specifically, the temperature is 200° C., and the annealing time is 1.5 h. In the disclosure, the third annealing stabilizes the structural integrity of the platinum-transition metal intermetallic framework, enhancing stability.

An argon-to-hydrogen ratio in the argon-hydrogen atmosphere used for the second annealing and the third annealing can be maintained within the safe range of 99:1 to 80:20.

In some embodiments, the transition metal acetylacetonate salt is one or more selected from the group consisting of iron acetylacetonate, nickel acetylacetonate, molybdenum acetylacetonate, vanadium acetylacetonate, copper acetylacetonate, manganese acetylacetonate, zinc acetylacetonate, titanium acetylacetonate, tungsten acetylacetonate, chromium acetylacetonate, and zirconium acetylacetonate. Specifically, the transition metal acetylacetonate salt is cobalt acetylacetonate. Platinum-cobalt alloys exhibit relatively high performance among reported platinum-based alloys and are a common alloy choice for catalyst applications. Using the platinum-cobalt alloy is beneficial for improving the performance of the catalyst.

Specifically, using chloroplatinic acid as a platinum source can lead to agglomeration upon decomposition at high temperatures. Current methods generally involve reducing metal particles at a low temperature first, then adding substances to limit particle agglomeration before high-temperature treatment. These added substances may remain after high-temperature annealing, often requiring further processing. Moreover, this process can affect the properties of the formed carbon layer, hindering solution diffusion on the catalyst surface during use and impacting catalytic effectiveness. In contrast, the disclosure uses acetylacetonate salts as the metal source. The acetone used is highly volatile and does not remain. During high-temperature treatment with graphitized carbon, the acetylacetonate salts are decomposed, and the decomposition products in situ form an encapsulating carbon layer that inhibits particle agglomeration. Compared to existing preparation methods, this approach allows for preparation in fewer operational steps, with simpler synthesis and lower cost.

In some embodiments, a platinum loading in the carbon-supported metal catalyst is in a range of 1-60 wt %, specifically 5-60 wt %.

The disclosure further provides a carbon-supported metal catalyst, including a carbon support having metal nanoparticles supported and distributed thereon, in which a surface of the metal nanoparticles is encapsulated with a carbon layer.

Specifically, in the provided carbon-supported metal catalyst, the metal nanoparticles are uniformly distributed on the carbon support, and each metal particle on the carbon support is encapsulated by the carbon layer.

In some embodiments, the carbon support can be one of solid nanoparticles or a porous continuous structure. The solid nanoparticles have a particle size of 1 nanometer (nm) to 300 micrometers (μm). The carbon support, whether the solid nanoparticles or the porous continuous structure, includes commercial carbon materials and graphitized carbon.

In some embodiments, the metal nanoparticles have a particle size of 1-20 nm, specifically 3-5 nm. Specifically, the metal nanoparticles can be intermetallic compounds including one or more of platinum, iron, nickel, molybdenum, vanadium, copper, manganese, zinc, titanium, tungsten, chromium, and zirconium. More specifically, the metal nanoparticles are platinum nanoparticles or platinum-based intermetallic compound nanoparticles. The particle size of the metal nanoparticles can be determined by observing scanning transmission electron microscopy (STEM) images of the carbon-supported metal catalyst or from XRD test results.

In some embodiments, the pore structure within the carbon layer can be one of a loose porous structure, a trace pore structure, or a closed non-porous structure. Specifically, the pore structure within the carbon layer is the loose porous structure, which provides a larger electrochemical contact area and is beneficial for improving electrochemical performance.

Specifically, pore distribution of the encapsulating carbon layer can be observed via STEM images of the carbon-supported metal catalyst or inferred from electrochemical data. The loose porous structure is necessary for good electrochemically accessible area. Therefore, excellent electrochemical performance indicates that the encapsulating carbon layer possesses a loose porous structure.

In some embodiments, the encapsulation can be one of no encapsulation, partial encapsulation, or complete encapsulation, with complete encapsulation being preferred. The degree of encapsulation by the carbon layer can be observed via STEM images of the carbon-supported metal catalyst.

In some embodiments, the carbon layer has a thickness of 0.001-50 nm, specifically 0.01 nm-3 nm. The thickness of the carbon layer can be observed via STEM images of the carbon-supported metal catalyst.

In some embodiments, the carbon layer is in a range of 0 to 50 layers in quantity, specifically 1 to 2 layers. The number of layers in the carbon layer can be observed via STEM images of the carbon-supported metal catalyst.

Specifically, the provided carbon-supported metal catalyst can also be prepared by the preparation method of the carbon-supported metal catalyst as described above. Through the preparation method provided in the disclosure, the structure and properties of the carbon support can be maintained, allowing preparation on the desired carbon support as needed. In the obtained carbon-supported metal catalyst, the metal nanoparticles are completely encapsulated by a loose porous carbon layer. The carbon layer has a thickness of less than 3 nm and includes fewer than 2 layers. By controlling the annealing conditions, the thickness and number of layers of the carbon layer formed from the acetylacetonate groups can be tuned. The metal nanoparticles have a particle size of 1-20 nm. This carbon-supported metal catalyst exhibits good catalytic performance, high stability, and high cycling durability.

The following specific embodiments are provided for further illustration.

### Embodiment 1

The preparation method of the graphitized carbon-supported platinum-cobalt intermetallic compound catalyst of the embodiment 1 of the disclosure includes steps as follows.

Platinum acetylacetonate, cobalt acetylacetonate, and 150 mg of graphitized carbon are dispersed in 7 mL of acetone and ultrasonicated to achieve uniformity to obtain a mixed material. The platinum loading is controlled at 30 wt %, and the cobalt loading is controlled at 30 wt %. The mixed material is dried by rotary evaporation to remove the acetone, yielding the precursor of the embodiment 1. This precursor is then subjected to a first annealing in an air atmosphere at 176° C. for 20 min to obtain a mixture.

The mixture is subjected to a second annealing in an argon-hydrogen atmosphere at 700° C. for 6 h. After cooling, the cooled mixture is placed in 0.25 mol/L sulfuric acid and performed with acid washing at 60° C. for 12 h. After the acid washing, the catalyst is washed with deionized water, dried in a vacuum oven at 65° C., and then subjected to a third annealing in an argon-hydrogen atmosphere at 200° C. for 1.5 h, yielding the graphitized carbon-supported platinum-cobalt intermetallic compound catalyst of the embodiment 1.

The graphitized carbon used in the embodiment 1 is prepared by heat-treating an amorphous carbon material in an argon atmosphere at 1800° C. for 75 min, followed by natural cooling to room temperature.

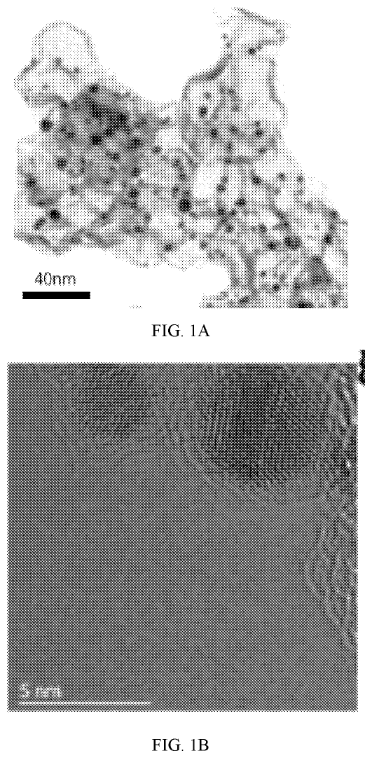

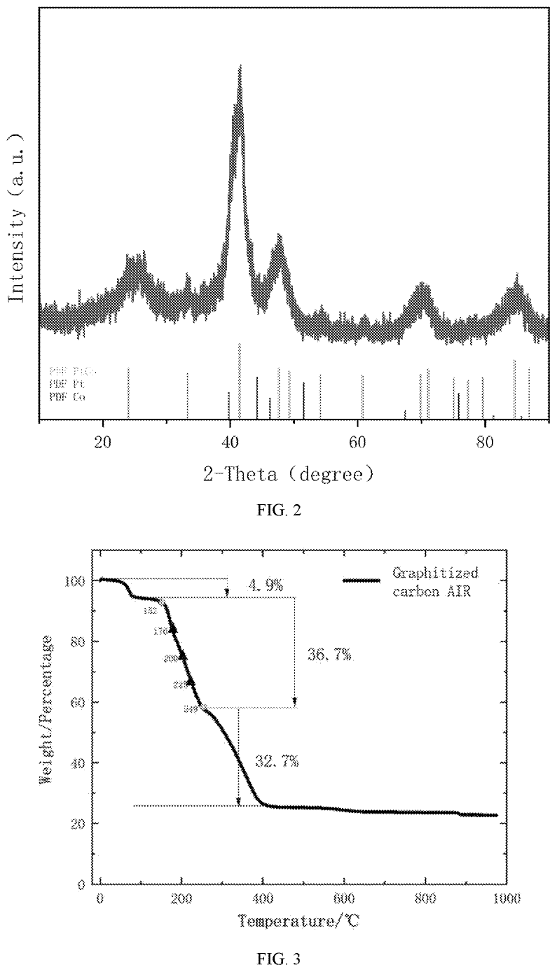

The particle distribution and electron microscope images of the graphitized carbon-supported platinum-cobalt intermetallic compound catalyst of the embodiment 1, obtained by STEM, are shown in FIGS. 1A and 1B, respectively. Observation reveals that the particles are uniformly distributed on the graphitized carbon surface. The carbon support is loaded with platinum-cobalt intermetallic compound particles, and the particle surfaces are completely encapsulated by a thin carbon layer having a thickness of less than 2.5 nm. The XRD pattern of the embodiment 1 is shown in FIG. 2. The XRD analysis confirms the successful preparation of Pt₁Co₁ (a platinum-cobalt intermetallic compound with a Pt/Co atomic ratio of 1/1). From the electron microscope images and XRD results, the particle size of the carbon-layer-encapsulated platinum-cobalt intermetallic compound particles is determined to be 4-5 nm. The TGA curve obtained by heating the precursor of the embodiment 1, containing the acetylacetonate salts and graphitized carbon, in air at a rate of 5° C./min is shown in FIG. 3.

### Embodiment 2

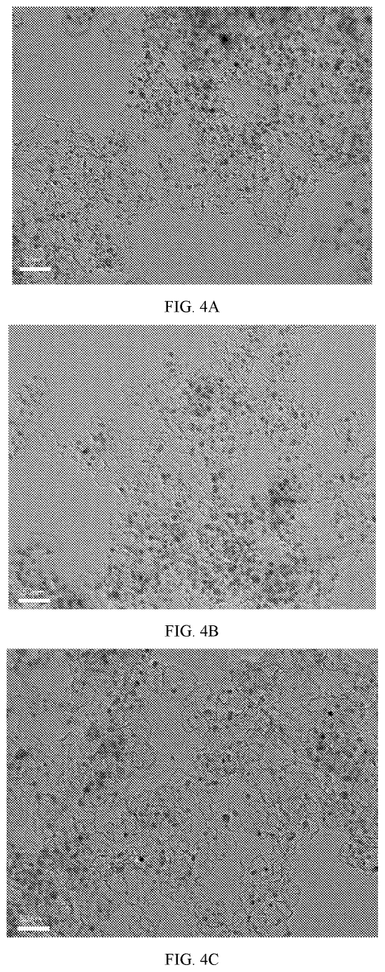

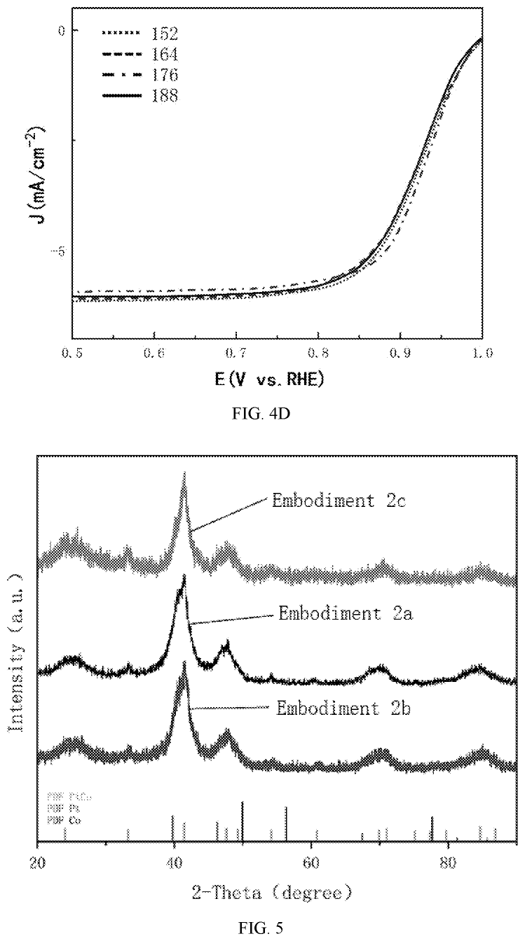

The preparation method of the graphitized carbon-supported platinum-cobalt intermetallic compound catalysts of the embodiment 2 is substantially the same as in the embodiment 1, with the difference that three separate portions of the precursor from the embodiment 1 are prepared and subjected to the first annealing at temperatures of 152° C., 164° C., and 188° C., respectively, designated as embodiment 2a, embodiment 2b, and embodiment 2c. The resulting graphitized carbon-supported platinum-cobalt intermetallic compound catalysts of the embodiment 2 are characterized by STEM and XRD. The particle distributions observed by STEM are shown in FIGS. 4A, 4B, and 4C. Observation reveals that the particles are uniformly distributed on the graphitized carbon surface. The carbon support is loaded with platinum-cobalt intermetallic compound particles, and the particle surfaces are completely encapsulated by a thin carbon layer, with slightly different carbon layer properties. The graphitized carbon-supported platinum-cobalt intermetallic compound catalysts prepared in the embodiment 1 and the embodiment 2 are subjected to activity testing. ORR tests are conducted in an electrochemical cell with an oxygen-saturated 0.1 moles per liter (M) HClO₄ solution at a scan rate of 20 millivolts per second (mV·s⁻¹). The ORR performance results for the embodiment 1 and the embodiment 2 are shown in FIG. 4D. It is observed that the ORR performance of the sample of the embodiment 1 annealed at 176° C. is relatively better. The XRD patterns are shown in FIG. 5. Observation indicates that the particle size increases with increasing temperature. Concurrently, the main peak shows features of a solid solution. The presence of small splits in the peaks might suggest that some particles are not fully alloyed. This indicates that the temperature of the first annealing also affects the bonding effect of the platinum-based metal. As the temperature increases, the effect of the carbon layer in restricting particle growth decreases, leading to larger particles.

### Embodiment 3

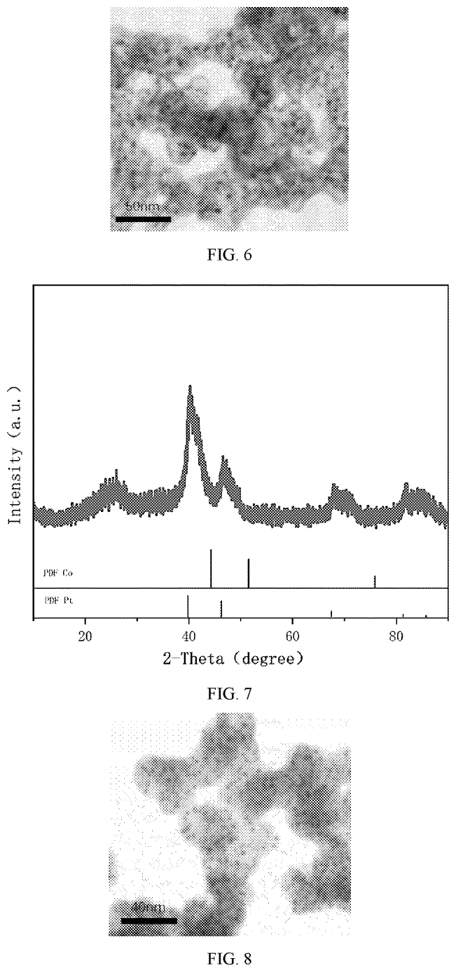

The preparation method of the graphitized carbon-supported platinum-cobalt intermetallic compound catalyst of the embodiment 3 is substantially the same as in the embodiment 1, with the difference that the second annealing is conducted in an argon-hydrogen atmosphere at 700° C. for 2 h. The resulting graphitized carbon-supported platinum-cobalt intermetallic compound catalyst of the embodiment 3 is characterized by STEM and XRD. The particle distribution observed by STEM is shown in FIG. 6. Observation reveals that the distribution of particles on the surface of graphitized carbon is relatively uneven. The carbon support is loaded with platinum-cobalt intermetallic compound particles, and the particle surfaces are completely encapsulated by a carbon layer. The XRD pattern is shown in FIG. 7. Electron microscopy shows a relatively uniform particle distribution, while the XRD pattern exhibits peaks characteristic of a solid solution, indicating that the annealing time of only two hours results in a lower degree of order, which is slightly inferior compared to the embodiment 1.

### Embodiment 4

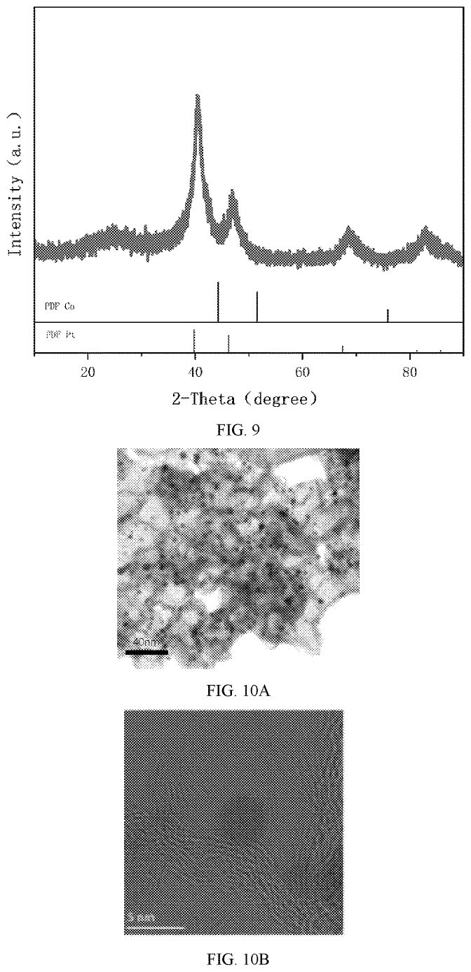

The preparation method of the carbon-supported platinum-cobalt intermetallic compound catalyst of the embodiment 4 is substantially the same as in the embodiment 1, with the difference that the graphitized carbon support is replaced with porous KB600 carbon. The resulting KB600-supported platinum-cobalt intermetallic compound catalyst of the embodiment 4 is characterized by STEM and XRD. The STEM results are shown in FIG. 8. Observation reveals that the particles are uniformly distributed on the carbon surface. The carbon support is loaded with platinum-cobalt intermetallic compound particles, and the particle surfaces are completely encapsulated by a thin carbon layer. The XRD pattern is shown in FIG. 9. Electron microscopy shows that the particles are uniformly distributed, but their degree of order is slightly lower than that of the embodiment 1 using graphitized carbon.

### COMPARATIVE EXAMPLES

### Comparative Example 1

The preparation method of the graphitized carbon-supported catalyst of the comparative example 1 includes steps as follows.

Platinum acetylacetonate, cobalt acetylacetonate, and graphitized carbon are dispersed in 7 mL of acetone and ultrasonicated to achieve uniformity. The platinum loading is controlled at 30 wt % to obtain a mixed material. The mixed material is dried by rotary evaporation to remove the acetone, yielding the precursor of the comparative example 1. The precursor is then subjected to annealing in an argon-hydrogen atmosphere at 700° C. for 6 h. After cooling, the cooled mixture is placed in 0.25 mol/L sulfuric acid and performed with acid washing at 60° C. for 12 h. After the acid washing, the catalyst is washed with deionized water, dried in a vacuum oven at 65° C., and then annealed in an argon-hydrogen atmosphere at 200° C. for 1.5 h, yielding the graphitized carbon-supported platinum-cobalt intermetallic compound catalyst of the comparative example 1.

Raw materials and the preparation method of the comparative example 1 are substantially the same as in the embodiment 1, with the difference that the precursor of the comparative example 1 is not subjected to the first annealing treatment in an air atmosphere. The resulting graphitized carbon-supported catalyst of the comparative example 1 is characterized by STEM and XRD. The particle distribution and electron microscope images obtained by STEM are shown in FIGS. 10A and 10B, respectively. STEM images show uniform particle distribution, with the particle surfaces completely encapsulated by a carbon layer. Compared to the embodiment 1, the carbon layer is thicker, reaching over 5 nm. The XRD results are shown in FIG. 11. It is observed that the sample not subjected to the first annealing exhibits a lower degree of order in the material, resulting in significantly lower activity compared to the example subjected to air annealing.

### Comparative Example 2

A commercially available Pt/C catalyst with a platinum loading of 40 wt % is used at a loading of 20.0 micrograms of platinum per square centimeter (μg Pt/cm²).

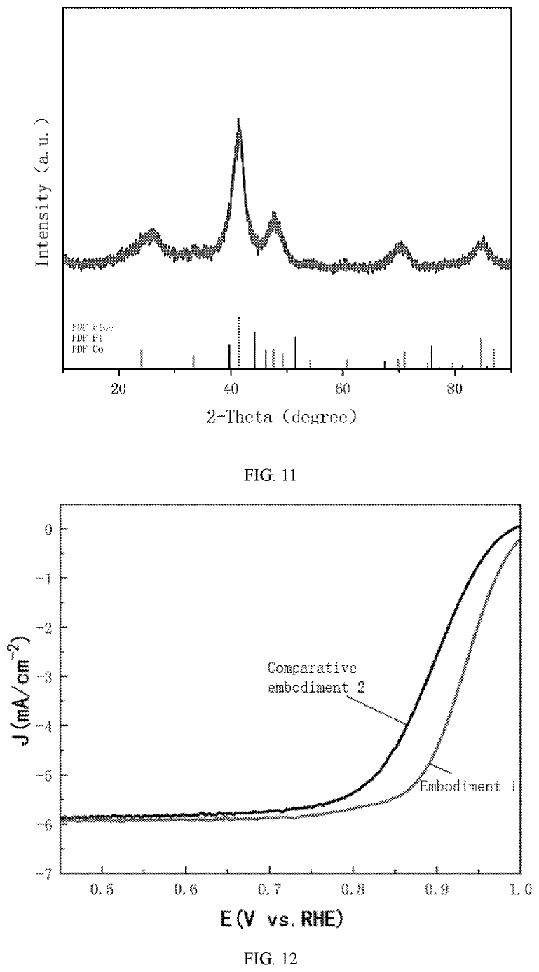

The graphitized carbon-supported platinum-cobalt intermetallic compound catalyst of the embodiment 1 and the commercial Pt/C catalyst of the comparative example 2 are subjected to the same activity test as in the embodiment 2. The activity test results are shown in FIG. 12. Comparing the polarization curves of the graphitized carbon-supported platinum-cobalt intermetallic compound catalyst and the commercial Pt/C catalyst, it is found that the mass activity (MA) of the catalyst of the embodiment 1, which underwent the air annealing pretreatment, is as high as 3162 amperes per milligram of platinum (A/mgPt), while the MA of the commercial Pt/C catalyst is 430 A/mgPt. This comparison demonstrates that the MA of the graphitized carbon-supported platinum-cobalt intermetallic compound of the embodiment 1 is 7-8 times that of the commercial Pt/C catalyst. The platinum-based intermetallic compound catalyst prepared by the preparation method of the disclosure possesses a significant activity advantage.

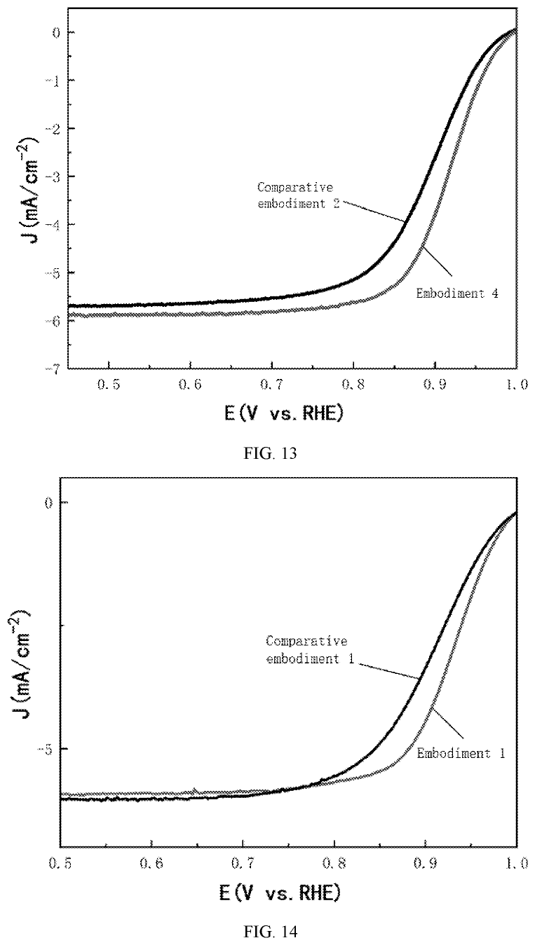

The KB600-supported platinum-cobalt intermetallic compound catalyst of the embodiment 4 and the commercial Pt/C catalyst of the comparative example 2 are subjected to the same activity test as in the embodiment 2. The activity test results are shown in FIG. 13. Comparing the polarization curves of the KB600-supported platinum-cobalt intermetallic compound catalyst and the commercial Pt/C catalyst, it is found that the MA of the catalyst of the embodiment 4, which underwent the air annealing pretreatment, is as high as 2030 A/mgPt, while the MA of the commercial Pt/C catalyst is 400 A/mgPt. This comparison demonstrates that the activity is still significantly higher than that of the commercial Pt/C catalyst. The platinum-based intermetallic compound catalyst prepared by the preparation method of the disclosure possesses a significant activity advantage.

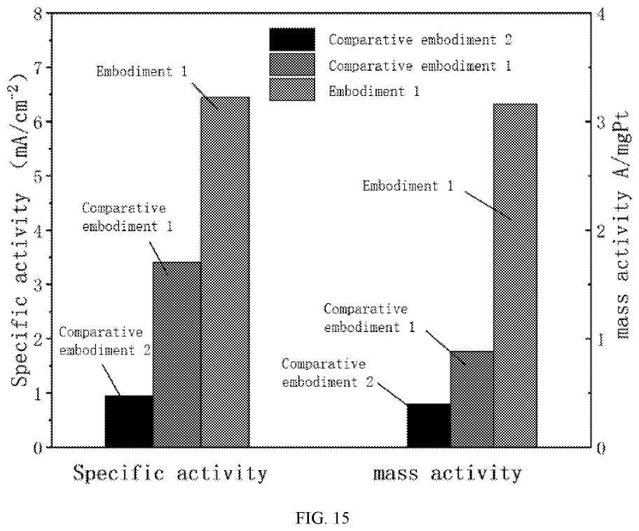

The graphitized carbon-supported platinum-cobalt intermetallic compound catalyst of the embodiment 1 and the graphitized carbon-supported catalyst of the comparative example 1 are subjected to the same activity test as in the embodiment 2. The activity test results are shown in FIG. 14. It is observed that the specific MA of the comparative example 1, which is not subjected to the first annealing, is 882 A/mgPt, lower than that of the embodiment 1. The electrochemical performance of the comparative example 1, with its thicker carbon layer, is inferior to that of the embodiment 1, indicating that the properties of the carbon layer affect the electrochemical activity. Furthermore, the degree of porosity of the carbon layer in the comparative example 1 is lower than that in the embodiment 1, suggesting that the pre-oxidation treatment in air according to the disclosure can enhance catalyst activity. A bar chart comparing the specific activity values of the embodiment 1, the comparative example 1, and the comparative example 2 is shown in FIG. 15. The embodiment 1 exhibits good electrochemical performance and the loose porous carbon layer provided a favorable electrochemically accessible surface area. The preparation method provided in the disclosure can effectively improve catalyst activity.

It should be understood that the application of the disclosure is not limited to the examples described above. For those skilled in the art, modifications or variations can be made based on the above description. All such modifications and variations shall fall within the scope of the disclosure.

What is claimed is:

1. A preparation method of a carbon-supported metal catalyst, comprising the following steps:
dispersing platinum acetylacetonate, a transition metal acetylacetonate salt, and a carbon material in a solvent, removing the solvent by drying to obtain a precursor, and performing a first annealing on the precursor in an air atmosphere to obtain a mixture; and
performing a second annealing on the mixture in an argon-hydrogen atmosphere to obtain an annealed mixture, cooling the annealed mixture to obtain a cooled mixture, then performing acid washing on the cooled mixture, followed by washing and drying to obtain a resulting product, and performing a third annealing on the resulting product in the argon-hydrogen atmosphere to obtain the carbon-supported metal catalyst;
wherein a temperature of the first annealing is in a range of 100-188° C. and a period of the first annealing is in a range of 5-500 minutes (min);
wherein the mixture exhibits a weight loss in a range of 1-50 weight percent (wt %) after the first annealing compared to before the first annealing;
wherein a temperature of the second annealing is in a range of 400-1100° C. and a period of the second annealing is in a range of 10 min to 8 hours (h); and
wherein a temperature of the third annealing is in a range of 100-500° C. and a period of the third annealing is in a range of 10 min to 6 h.

2. The preparation method of the carbon-supported metal catalyst as claimed in claim 1, wherein the temperature of the first annealing is 176° C. and the period of the first annealing is in a range of 20-40 min; and
the mixture exhibits the weight loss in a range of 1-30 wt % after the first annealing compared to before the first annealing.

3. The preparation method of the carbon-supported metal catalyst as claimed in claim 1, wherein the acid washing is performed in sulfuric acid with a concentration in a range of 0.1-1 mole per liter (mol/L) at 60° C. for 12 h.

4. The preparation method of the carbon-supported metal catalyst as claimed in claim 1, wherein the carbon material comprises graphitized carbon or a commercial carbon material;
wherein the graphitized carbon is prepared by heat-treating an amorphous carbon material in an inert atmosphere or a nitrogen atmosphere at 1200-3000° C. for 10 min to 6 h, followed by natural cooling to room temperature; and
wherein the commercial carbon material is one selected from the group consisting of Vulcan® XC72, KB300, KB600, BP 2000, and Toray® carbon.

5. The preparation method of the carbon-supported metal catalyst as claimed in claim 1, wherein the transition metal acetylacetonate salt is one or more selected from the group consisting of iron acetylacetonate, nickel acetylacetonate, molybdenum acetylacetonate, vanadium acetylacetonate, copper acetylacetonate, manganese acetylacetonate, zinc acetylacetonate, titanium acetylacetonate, tungsten acetylacetonate, chromium acetylacetonate, and zirconium acetylacetonate.

6. The preparation method of the carbon-supported metal catalyst as claimed in claim 1, wherein a platinum loading in the carbon-supported metal catalyst is in a range of 1-60 wt %.

7. The carbon-supported metal catalyst prepared by the method as claimed in claim 1, comprising a carbon support loaded with metal nanoparticles, wherein a surface of the metal nanoparticles has a carbon layer by encapsulation;
wherein the carbon support is one of solid nanoparticles or a porous continuous structure, the solid nanoparticles having a particle size of 1 nanometer (nm) to 300 micrometers (μm);
wherein the metal nanoparticles have a particle size in a range of 1-20 nm;
wherein a pore structure within the carbon layer is one of a loose porous structure, a trace pore structure, or a closed non-porous structure;
wherein the encapsulation is one of partial encapsulation or complete encapsulation;
wherein the carbon layer has a thickness in a range of 0.01-3 nm; and
wherein the carbon layer is in a range of 1-2 layers in quantity.
